(19) United States
(12) Patent Application Publication
(10) Pub. No.: US 2023/0027291 A1
(43) Pub. Date: Jan. 26, 2023

(54) METHODS AND DEVICES FOR LOW DISTRACTION OPERATION OF A BIKE RIDER GROUP

(71) Applicant: AUTOTALKS LTD., Kfar Netter (IL)

(72) Inventors: Onn Haran, Bnei Dror (IL); Ohad Ashery Bonaventura, Tel Aviv (IL)

(21) Appl. No.: 17/494,861

(22) Filed: Oct. 6, 2021

Related U.S. Application Data
(60) Provisional application No. 63/224,417, filed on Jul. 22, 2021.

(51) Int. Cl. H04W 4/46; G08G 1/00; H04W 4/08

(52) U.S. Cl. CPC H04W 4/46; G08G 1/22; H04W 4/08

(57) ABSTRACT

Devices for low distraction operation of a bike rider group and methods for performing same. A device installed in a bike carrying a member of a bike rider group acting as self-rider, may comprise a rider input analyzer module configured to analyze a self-input provided by the self-rider and to provide a data element reflecting the self-input, a radio modem for sending a V2X message that includes the data element reflecting the self-input and for receiving V2X message that includes a data element from a remote member of the bike rider group, an alert analyzer module configured to detect an alert relevant to the self-rider based on the data element reflecting the self-input and on the data element received from the remote member, and a display configured to display the alert relevant to the self-rider with minimal distraction to the self-rider.

### CROSS REFERENCE TO RELATED APPLICATIONS

This application claims priority from U.S. Provisional Patent Application No. 63/224,417 filed Jul. 22, 2021, which is incorporated herein by reference in its entirety.

### FIELD

Embodiments disclosed herein relate generally to operation of a bike rider group, and in particular to communication between members of a bike rider group needed to guide and assist each other.

### BACKGROUND

Bike riding is a social activity. As used here, “bike” refers for example to bicycles, motorcycles and eScooters. It is common to see groups of riders riding together. Communication between such riders (also referred to as “group members”) is essential, since rider voices are not heard across distances normally extending between group members. The goal of communication is to enable group members to guide and assist each other, for example, detecting that a group member is stuck behind. Hand gestures may be used to notify group members behind, but a rider in front (“group leader”) cannot easily receive messages from other group members.

Ad-hoc groups are commonly created for other purposes, such as chats or gaming. In such cases, a centralized server holds the identities (IDs) of all network users and can route to connect two or more different users based on their IDs. This cannot be applied in a vehicle-to-everything (V2X) network. A centralized routing entity is not supported by V2X, since no entity holds the IDs of users and since V2X communication is ad-hoc.

Bluetooth-based solutions are available for group communication. A group in a Bluetooth-based solution is paired sequentially, meaning member A is paired with member B, member B with member C, member C with member D, B accepts C-D pairing, and then A accepts B-C-D pairing. This is very limiting and not intuitive. A group of people would desire to pair in an arbitrary order. Furthermore, the Bluetooth communication range is far shorter than that of V2X, which is a challenge in outdoor riding, where the surroundings, like trees, height changes, and rocks, already reduce the communication range.

A rider needs to keep the hands on the handlebar. As such, the rider cannot type or read text messages. A smartphone is a great tool for voice communication, but not all outdoor areas are covered by cellular reception, and bike status is not conveyed in the audio messages.

It would be advantageous to have a method and device for communication between rider group members with low (or minimal) distraction to a rider, allowing simple group creation, automatic message generation, intuitive display and simple human-machine interfacing.

### SUMMARY

In various embodiments, there are provided devices installed in a bike carrying a member of a bike rider group acting as self-rider, comprising: a rider input analyzer module configured to analyze a self-input provided by the self-rider and to provide a data element reflecting the self-input; a radio modem for sending a V2X message that includes the data element reflecting the self-input and for receiving V2X message that includes a data element from a remote member of the bike rider group; an alert analyzer module configured to detect an alert relevant to the self-rider based on the data element reflecting the self-input and on the data element received from the remote member of the bike rider group; and a display configured to display the alert relevant to the self-rider with minimal distraction to the self-rider.

In some embodiments, a device further comprises a software stack module configured to process the data element reflecting the self-input and the data element received from the remote member of the bike rider group.

In some embodiments, a device further comprises means configured to provide the self-input. The means may be configured to provide the self-input through a duration of a click action using a button of the device.

In some embodiments, a device further comprises a group control module for managing a list of riders in the bike rider group.

In some embodiments, the self-alert or the remote alert include a SOS alert.

In some embodiments, the self-alert or the remote alert include a departing member alert.

In various embodiments, there are provided methods, comprising: in a bike carrying a member of a bike rider group acting as self-rider: detecting an alert relevant to the self-rider based on a data element reflecting a self-input provided by the self-rider and on a data element received from another member of the bike rider group using V2X communications; and displaying the alert relevant to the self-rider with minimal distraction to the self-rider.

In some method embodiments, the self-input is provided by the self-rider by clicking for a predetermined duration on a button of a device running the method.

### BRIEF DESCRIPTION OF THE DRAWINGS

Non-limiting examples of embodiments disclosed herein are described below with reference to figures attached hereto that are listed following this paragraph. The drawings and descriptions are meant to illuminate and clarify embodiments disclosed herein and should not be considered limiting in any way.

FIG. 1A illustrates in a flow chart an embodiment of V2X group communication operation disclosed herein showing in (a) an alert generation process and in (b) an alert display process;

FIG. 1B illustrates a block diagram of V2X low distraction bike-safety device disclosed herein;

FIG. 2 illustrates a flow chart of the V2X ad-hoc group management;

FIG. 3 illustrates a flow chart of message reception;

FIG. 4A illustrates a flow chart of automatic slowdown alert generation;

FIG. 4B illustrates a flow chart of automatic SOS alert generation;

FIG. 4C illustrates flow charts of automatic watch-out event alert generation and display;

FIG. 4D illustrates a flow chart of gesture-triggered alert generation;

FIG. 5 illustrates options for data elements transmission;

FIG. 6 illustrates a flow chart for displaying group members;

FIG. 7 illustrates a flow chart for bike computer single-button control.

### DETAILED DESCRIPTION

Various embodiments disclose disclosed herein provide methods and device for low (or minimal) distraction operation of a rider group. “Low distraction” or “minimal distraction” are terms that refer to the fact that a rider needs to perform some actions (such as touching a button or pressing on a screen) but the complexity (e.g. in terms of number of actions) of the operation is minimized. Each rider performing or using a method disclosed herein is a “self-rider” riding a self-bike and performing or using the method on a self-device.

A new set of data elements embedded in transmitted V2X messages are defined for managing group membership and exchanging information between group members. Exemplary new data elements for group management and alerts are listed in Table 1.

TABLE 1

| Data element | Short description |
|---|---|
| Group | 4-6 digits |
| Number | |
| Alert | 0: no alert |
| | 1: SOS |
| | 2: slowdown |
| | 3: watch out |
| | 4: good |
| | 5: bad |
| Join control[0]- | 0: Join not allowed |
| Join enable | 1: Join allowed |
| Join | 0: No group changes |
| control[2:1]- | 1: Member joined |
| Member control | 2: Removed the last member |
| Rider/group | Optional text. The text can be |
| name | an alias to protect privacy |

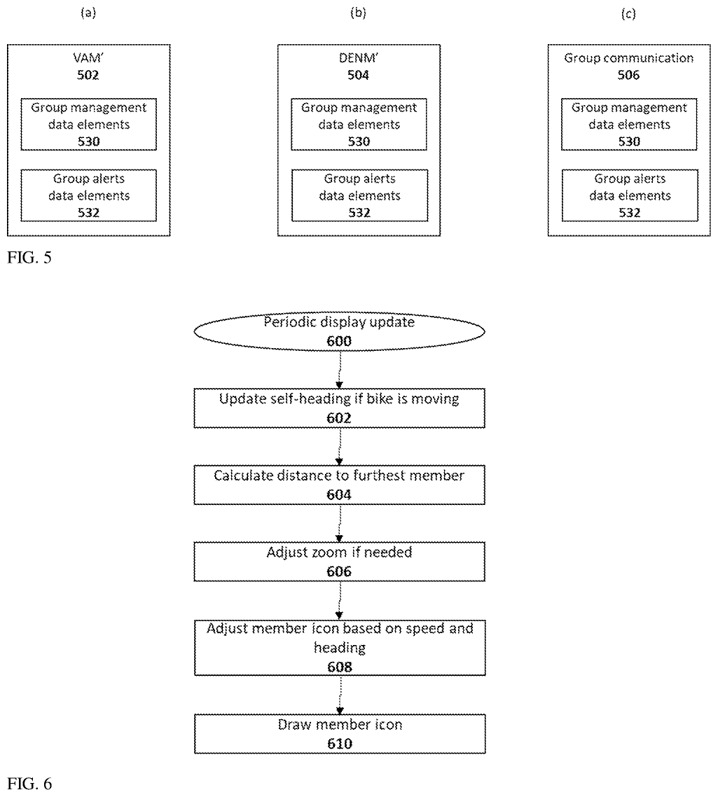

A group message is transmitted periodically by all members (typically every 1 second), preferably attached to the periodic safety message (VAM in the European standard, and PSM in the US standard), as explained with reference to FIG. 6. V2X security measures are applied to the messages without additional encryption, as the new data elements do not reveal the identity and actions of the rider. Furthermore, for a SOS alert message to reach any V2X rider for getting assistance, such a message should not be encrypted.

All group members, including an initiator (organizer) of the group, have identical rights.

Group management and communication should have a minimal impact on rider attention and minimal demand for rider actions. In various embodiments, the messages are limited to simple pre-defined alerts, which may be represented by intuitive icons. The alerts are displayed relative to the location of the self-rider and can optionally show other group members' progress. In addition, all alerts can be activated automatically, without rider involvement, based on analyzing riding patterns using self-bike accelerometers or data elements received in messages from other group members, see description of module 156 below.

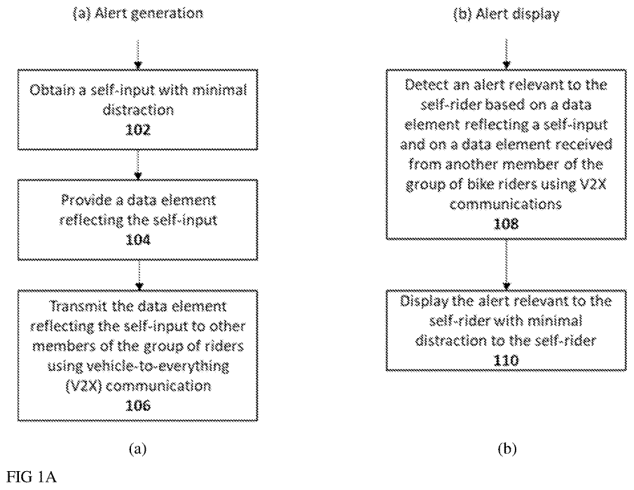

FIG. 1A illustrates in a flow chart an embodiment of a method for low distraction operation of a rider group using V2X group communications disclosed herein. It shows two flows: (a) for alert generation and (b) for alert display. The method may be implemented in a device like device 150 in FIG. 1B. Device 150 may be installed in each bike. Each rider using (controlling, operating) device 150 on his/her own bike is referred to as a “self-rider”.

For alert generation FIG. 1A (a), performed by a rider as a self-rider, operation begins in step 102, where the device receives self-rider inputs, typically entered using of entering the self-input (e.g. a button or a touch screen on the device) with minimal distraction to the self-rider. The rider is focused on the road ahead, and his/her hands should be kept on the handlebar to keep balance. Therefore, the rider cannot handle complex menus or search for “right” means of entering the self-input. Exemplary means may include a single button 162 in FIG. 1B. A rider input analyzer module 160 in device 150 parses the self-inputs to determine if a self-input indicates an alert. If yes, a data element reflecting the self-input (see e.g. Table 1) is provided by module 160 in step 104. In step 106, the device, using V2X, transmits the data element reflecting the self-input to other members of the rider group using V2X communications. Such data elements enhance capabilities of a V2X software (SW) stack 154, FIG. 1B, which is therefore “enhanced” and are used in the alert display flow in FIG. 1A (b).

For alert display FIG. 1A (b), performed by a rider as a self-rider, the device receives at least one data element from another (remote) rider (group member) via V2X, thus having this received data element in addition to his/her own self-input related data element “self-data element”) for further processing/analysis. In step 108, the device detects an alert relevant to the self-rider based on the self-data element and the received data element using an alert analysis module 156, FIG. 1B. This analysis uses information in the data elements such as location, speed and heading. Alert situations such as a fallen rider or departing group member are identified based on the information in the data elements. Lastly, in step 110, the device displays the alert relevant to the self-rider on a display screen of the device while minimizing the distraction to the self-rider. The “minimizing distraction” aspect is reflected for example by the fact that a “watch-out event” (or in general an “alert event is displayed only when a rider approaches the event. This is explained in more detail below. Other alerts, such as “departing biker”, are displayed without overloading the display screen with irrelevant data.

FIG. 1B illustrates in a block diagram an embodiment of a V2X low distraction bike-safety device for performing a method as in FIGS. 1A (a) and (b), the device numbered 150. Device 150 comprises a radio (communication) modem 152 for sending a V2X message that includes the self-data element and for receiving a V2X message that includes a data element from a remote member of the group of bike riders. Modem 152 may use any V2X standard, for example 802.11p or C-V2X. Device 150 further comprises an enhanced software (SW) stack 154 that implements a V2X protocol stack for personal safety, such as PSM in US or VAM in Europe, with enhancements to support group communication. The enhancement expresses the fact that SW stack 154 supports group communication, as opposed to known SW stacks that do not support group communication. Enhanced SW stack 154 processes, in both receive and transmit directions, new data elements, as defined in Table 1 for enabling the group communication operation. The new data elements are parsed from received messages. Device 150 may further comprise an alert analyzer module 156 configured to detect an alert relevant to the self-rider based on the self-data element and on the data element received from the remote member. In the analysis, received data elements are compared with self-sensors. A self-alert may include for example an alert indicating a fallen rider, generated in the self-rider device when the self-rider falls. A remote alert may include for example an alert from another rider that he/she is departing the group. Device 150 may further comprise a GNSS (global navigation satellite system) device 158 with inertial sensors for providing local (self) positioning and movement of device 150. Information from these sensors is also used to detect alerts related to self-inputs. Device 150 may further comprise a rider input analyzer module 160 configured to parse the self-inputs, analyze a self-input and to provide a self-data element reflecting the self-input. Device 150 may further comprise a group control module 164 for managing a list of riders (members) in the group, if existing. Device 150 may further comprise a simplified human-machine interface (HMI) with means for entering the self-input (e.g. a button 162), and a display 166 configured to display the alert relevant to the self-rider with minimal distraction to the self-rider with an optional touch sensing functionality. The device may further comprise sound feedback and/or haptic feedback means (e.g. a buzzer) 168 for attracting the attention of the cyclist to the display. Display 166 may have a screen for showing the alerts.

Stack 154 and modules 156 and 160 may be included in, or interact with a processor of the device (not shown).

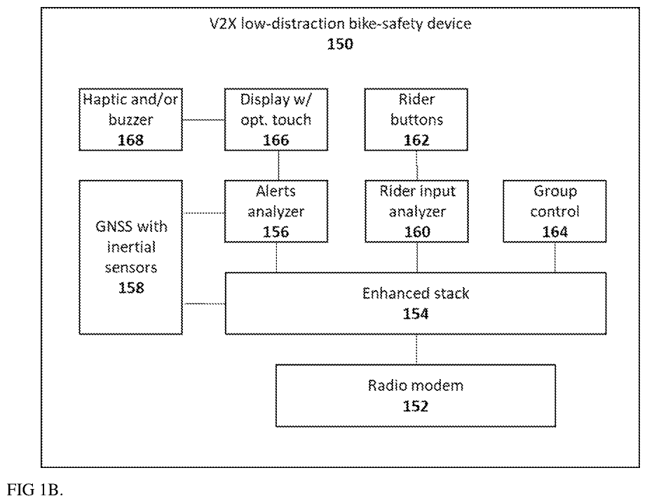

FIG. 2 illustrates a flow chart of exemplary V2X ad-hoc group management performed by group control module 164. The operation begins in step 200 after the device is powered. The operation continues to step 202, where received messages are searched (scanned) to find existence of groups. Each device 150 searches for groups within a given V2X communication range. Each received message is parsed by enhanced software stack 154. If a message includes a data element containing a group number, then a group associated with that number is identified. Next, a check in step 204 checks if the rider decided to create a new group (i.e. is an initiator). The rider can initiate creation of a new group through an interface, typically buttons like buttons 162. If Yes, the group is created by generation of a new group number, the rider becomes part of the group, and the operation continues to step 208. If No, the operation continues to step 206, which checks if the rider selected to join a group from the groups detected during the scan in step 202. If Yes, the rider becomes part of the selected group, and the operation continues to step 208. If No, the operation returns to step 202, where the steps are repeated, and the rider remains not part of any group.

In step 208, a check if performed to check if a new rider joined the group. This is indicated if a rider, previously unknown, uses the same group number used by the self-rider and all other members in his group in their messages. If No, there is no change in the group membership, and the operation returns to step 208. If Yes, the operation continues to step 210, where a check is made if the new (previously unknown) rider is eligible to join the group. The eligibility conditions require all group members to be within a short distance from each other, for example 20 meters, that all group members should stand still, for example with speed lower than 3 km/h, and that no existing group member rejects the new rider. One of the data elements in the messages mentioned above may indicate rejection of the last rider attempting to join the group, as well as addition of a new group member. Without eligibility, a rider attempting to join the group is not added to the group, and his/her messages are ignored. The operation returns to step 208. Otherwise, the rider attempting to join the group is added to the group in step 212. Next, the operation returns to step 208.

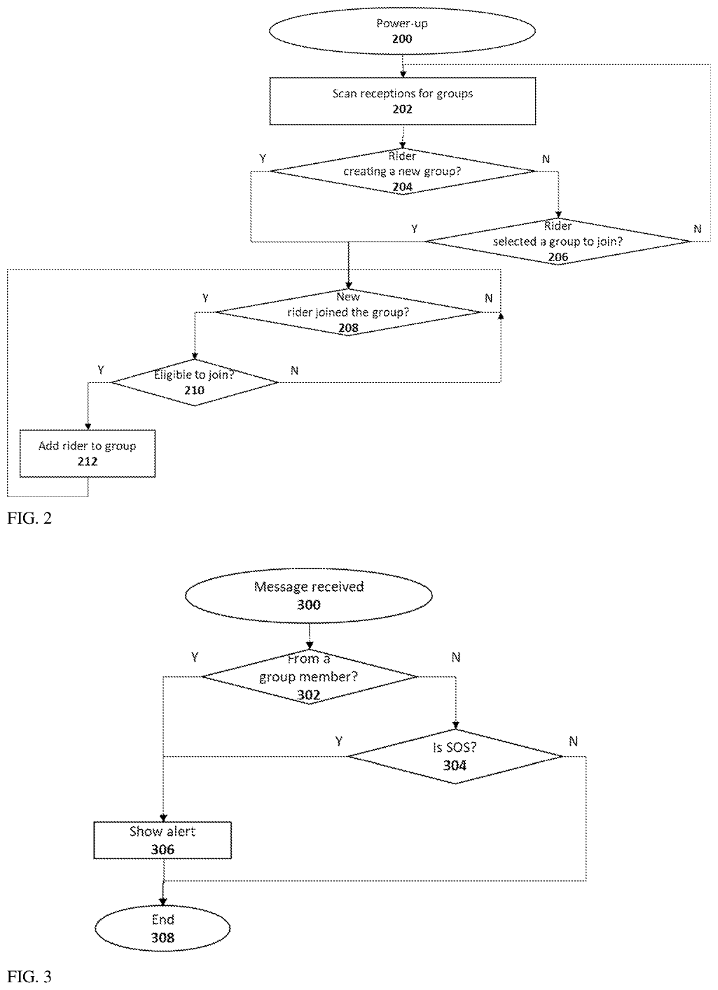

FIG. 3 illustrates a flow chart of message reception, implemented by enhanced stack 154. The operation begins after a message is received in step 300. If the message is received from a group member (Yes), then the operation continues to step 306, where the alert is displayed on the bike display 166. Otherwise (No), the operation continues to step 304, where a check is made if the received message contained a SOS alert. If No, the received message is ignored, and the operation ends in step 308. If Yes, the operation continues to step 306, where the SOS alert is displayed on the bike display. After displaying the alert, the operation ends in step 308.

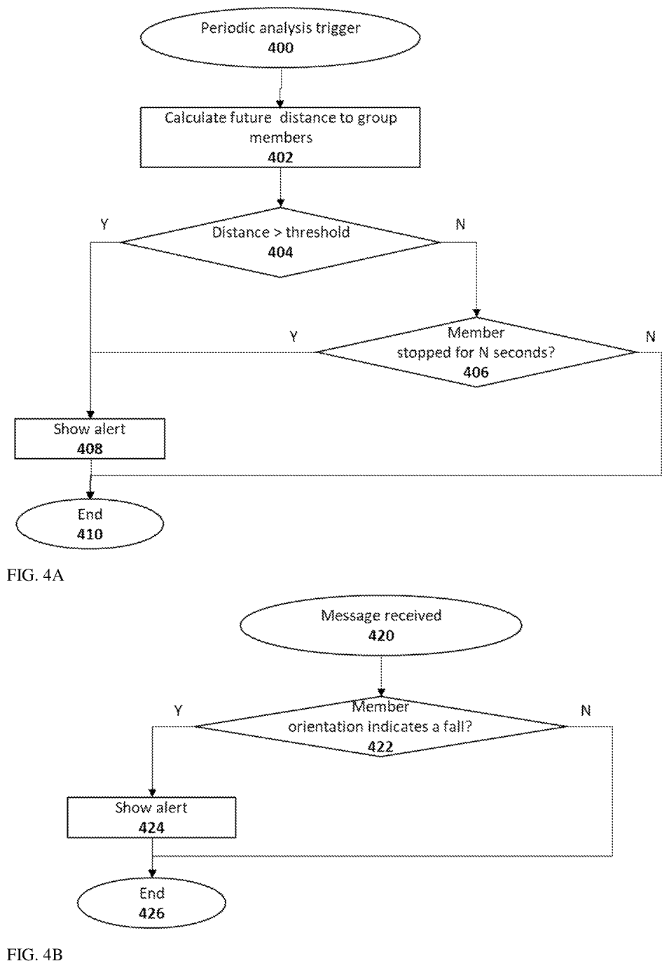

FIG. 4A illustrates a flow chart of automatic slowdown alert generation, implemented by the alert analyzer module 156. The operation begins periodically in step 400, for example, every 1 second. Next, in step 402, future distances of each of the group members to the self-member is calculated. Future distance is predicted N seconds ahead, for example, N=3, based on current bike location, speed, acceleration and heading, using a movement model like a Kalman filter. A check is made in step 404 if the distance from the self-member to any other member is larger than a threshold, which can be either static, for example, 250 meters, or dynamic, for example, 2X of the average group length (the distance between the first rider and the last rider in the group). If the distance exceeds the threshold, the operation continues to step 408, where a slowdown alert (a self-alert displayed on the self-display) is displayed. Otherwise, the operation continues to step 406, where a check is made if one group member stopped for N seconds, for example 20 seconds. If an additional group member stopped, then N drops to for example to 10 seconds, and if more additional group members stopped, then N may further drop to, for example, to 7 seconds. If Yes in step 406, the operation continues to step 408, where one or more alerts is/are displayed on the self-display. If No in step 406, operation ends in step 410.

To summarize—above there is a check against threshold to detect if one or more remote riders stop and if yes, a self-rider has an alert is displayed on his/her display. The self-rider may decide to slow down after seeing this alert.

FIG. 4B illustrates a flow chart of exemplary automatic SOS alert generation, implemented by alert analyzer module 156. The operation begins in step 420 after a message was received by the self-rider from another remote rider. Next, in step 422, a check is made if the member orientation in the remote rider's message indicates a fall, meaning the handlebar longitudinal axis indicates the bike is laying on the ground. If Yes, the operation continues to step 424 where an SOS alert is displayed. Otherwise (No), the operation ends in step 426.

FIG. 4C illustrates flow charts of exemplary automatic watch-out event alert generation and display, implemented by generating alerts in rider input analyzer 160 and by determining the display time in the alert analyzer module 156. Flow chart (a) illustrates the watch-out event alert generation. The operation begins in step 440 after accelerometer readings are received by the self-rider. The accelerometers provide speed changes in all 3 (XYZ) axes, where XY represent the road surface and Z represents the height (vertical) axis. Next, in step 442, a watch-out event is identified. The “watch-out” term refers to a bike movement for avoiding a risk that most likely resulted from the terrain and less from interaction with other riders. Examples of such events may include passing over a fallen tree, in mud, over a large stone, riding on gravel, etc. Usually, interactions with other road users, such as emergency braking, do not have a significant Z-axis change. Therefore, an event should combine large or persistent Z-axis changes along with speed or yaw-rate. Yaw-rate is defined as a bike's angular velocity about its vertical axis. An event is identified after persisting for several readings. Next, in step 444, the identified event is transmitted as a watch-out alert in the self-to-remote bike message. Next, the operation ends in step 446. Note that the actions in steps 444 and 446 are automatic, without rider intervention. Manual rider triggering is possible as well. A rider can send a watch-out event, optionally indicating two different cases: the first case is a local risk at the current position of the rider, which should be applicable for the receiving rider once getting close to the position. If the transmitting bike is 200 m ahead, the receiving rider will not remember the exact location to pay attention to. The second case is an “immediate” risk without a specific position and issued immediately to the receiving rider. The distinction between the triggering of the two cases may be based on the duration of the button press, for example, shorter for a local risk and longer for an immediate risk.

FIG. 4C (b) illustrates an exemplary display of a watch-out event alert. The operation begins in step 450 after a watch-out event message is received. Next, in step 451, a check is made if the alert is not associated with a position, or in other words is an immediate alert. If Yes, the alert is displayed in step 458. Otherwise (No), the operation continues to step 452, where the event is stored. The event is kept inside the memory as long as its position is within 1 km, or another distance, from the self-rider. Next, in step 454, the future position of the self-rider is calculated based on the movement model taking into account current location, speed, and acceleration. Next, in step 456, a check is made if the location of the watch-out event is close on the future rider path, for example within 10 m ahead. If Yes, in step 458, an alert is displayed. If No in step 456 or after display of the alert in step 458, operation ends in step 459.

FIG. 4D illustrates a flow chart of exemplary gesture-triggered alert generation, implemented by generating the alerts in rider input analyzer 160, which analyzes existence of self (“good” and “bad” alerts of Table 1) alerts. The goal is to enable the rider to send messages to other group members without taking the hands off the handlebar. The operation begins in step 460, after the self-bike accelerometer readings are received. Next, in step 462, a check is made if a gesture by the self-rider was recognized by the self-device. Although arbitrary gestures can be defined, the concept is to use natural human gestures to avoid learning and remembering complex moves. For example, gestures may emulate head nodding, as used for Yes and No, indicating “good” (thumb-up) and “bad” (thumb-down) alerts respectively. In a bike, the movement of “No” may be emulated by shaking the bike from side to side, or by turning the handlebar from side to side. The bike orientation has to change from left to right to left and again. The movement of “Yes” is equivalent to acceleration, stopping, acceleration, and stopping again in a short period, for example in 10 seconds. If a gesture was recognized, the operation continues to step 464 where the respective alert (“good” or “bad”) is transmitted. Otherwise, the operation ends in step 466.

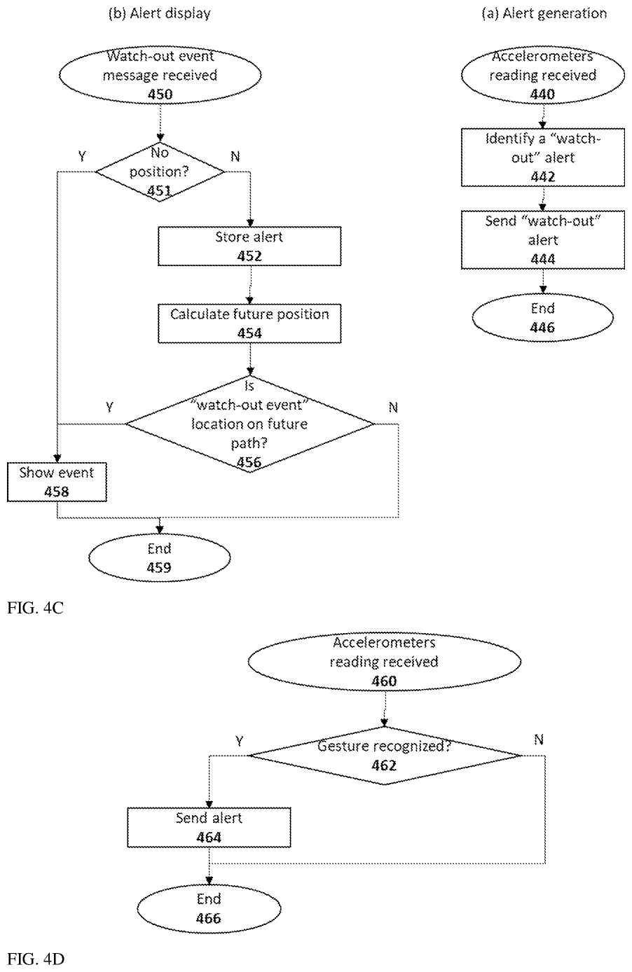

FIG. 5 illustrates exemplary options for adding new data elements to existing messages. The first exemplary option, in (a) is to carry group management data elements 530 and group alerts data elements 532 in a modified version of VAM, named here VAM′ 502. The extension is performed using ASN.1 ellipsis, marked as “ . . . ” which allows adding new data elements, which are ignored by older versions. The second option, in (b), is to similarly extend a DENM message, named here DENM′ 504. The advantage of this over VAM is that it utilizes the embedded multi-hop capability of DENM to extend the communication range. DENM is destined to carry special alerts, thus fitting the essence of alert messages. The last option, in (c), is to define a dedicated group communication message 506. The dedicated message can potentially use a different new radio channel, for example in the unlicensed ISM band. Using the new channel removes all constraints of the content of the message or carried data. On the other hand, another channel increases the solution cost by adding another communication channel.

FIG. 6 illustrates a flow chart for displaying group members along respective alerts. It is also possible to display just the alerts, without showing all members on a screen. The display is configured with a dynamic zoom feature. Operation begins in step 600 periodically, typically 10 times per second. Next, in step 602, the heading of the self-bike is updated, if the bike is moving. The reason is that the heading becomes incorrect if the bike stands still. Next, in step 604, the distance to the furthest group member is calculated. Next, in step 606, the zoom of the display is set accordingly to the calculated distance. If the rider configures dynamic zoom, the zoom is updated based on hysteresis. When the distance decreases below a certain threshold, zoom-in is applied, and when it increases above a different threshold, zoom-out is applied. Next, in step 608, icons of group members (not shown) are adjusted based on speed. A member icon may be longer if the speed is faster or may have a variable color, e.g. red for a fast-moving bike and blue for a standing bike.

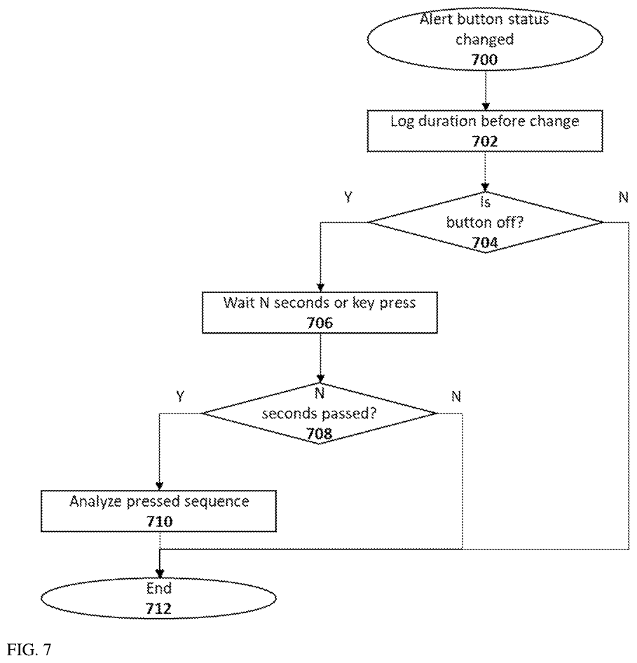

FIG. 7 illustrates a flow chart for bike computer single-button control, implemented by generating the alerts in rider input analyzer 160. Since the rider's hands need to be kept on the handlebar, searching for and pressing on buttons can impose a safety risk. Using a touchscreen may be complicated. Some bike computers have an optional unit of buttons, located at the handlebar next to the right thumb, for easy pressing to indicate actions. Each button can activate a specific alert, however, the number of alerts can be larger than the number of buttons. In such a case, a single button may be used to activate multiple different alerts. Exemplarily, the alerts may be indicated using duration and sequence of button presses. The number of alerts may be minimized to simplify the operation, for example by selecting only “watch-out”, “good” and “bad” alerts. The sequence may be similar to Morse code, where “watch-out” is the most common alert. Consequently, “watch out” may be indicated by the simplest method, namely “.” (single dot). A “bad” alert is the second most common alert, and may be indicated by “..” (double dot). For a “good” alert, the rider is less distracted, so he/she may be able to handle “--” (double dash) indications.

The operation begins in step 700 after the alert button status changed, e.g. to ON from OFF or vice versa. Next, in step 702, the time during which the button was at the previous state is logged. Next, a check is made in step 704 if the button is OFF. If No, the operation ends in step 712. If Yes, the operation continues to step 706. The operation waits for N seconds or for a button press, whichever arrives earlier. N may be typically min (5, 3xlast ON duration). For example, if the last press was 0.5 seconds long, it will wait for 1.5 seconds, but if the last press was 2 seconds long, it will wait for 5 seconds. After one of the two conditions became true, the operation continues to step 708, where it checks which condition ended the last step. If N seconds did not pass, the operation ends in step 712. Otherwise, the operation continues to step 710 where the pressed sequence is analyzed. If the duration of a pressed button is less than 1.5 seconds, then the press is identified as “.”. Otherwise, it is identified as “-”. (“single dash”=long press). All “.” and “-” indications are detected and matched with the known alert activation sequence. For example, if “good” is indicated by “..” then a “good” alert will be issued in that case.

It should be appreciated that the above-described methods and devices may be varied in many ways, including omitting or adding steps, changing the order of steps and the type of devices used. It should be appreciated that different features may be combined in different ways. In particular, not all the features shown above in a particular embodiment or implementation are necessary in every embodiment or implementation of the disclosure. Further combinations of the above features and implementations are also considered to be within the scope of some embodiments or implementations of the disclosure.

While certain features of the described implementations have been illustrated as described herein, many modifications, substitutions, changes and equivalents will now occur to those skilled in the art. It should be understood that they have been presented by way of example only, not limitation, and various changes in form and details may be made. Any portion of the device and/or methods described herein may be combined in any combination, except mutually exclusive combinations. The implementations described herein can include various combinations and/or sub-combinations of the functions, components and/or features of the different implementations described.

While this disclosure has been described in terms of certain embodiments and generally associated methods, alterations and permutations of the embodiments and methods will be apparent to those skilled in the art. The disclosure is to be understood as not limited by the specific embodiments described herein, but only by the scope of the appended claims.

What is claimed is:

1. A device installed in a bike carrying a member of a bike rider group acting as self-rider, the device comprising:
a rider input analyzer module configured to analyze a self-input provided by the self-rider and to provide a data element reflecting the self-input;
a radio modem for sending a vehicle-to-everything (V2X) message that includes the data element reflecting the self-input and for receiving a V2X message that includes a data element from a remote member of the bike rider group;
an alert analyzer module configured to detect an alert relevant to the self-rider based on the data element reflecting the self-input and on the data element received from the remote member of the bike rider group; and
a display configured to display the alert relevant to the self-rider with minimal distraction to the self-rider.

2. The device of claim 1, further comprising a software stack module configured to process the data element reflecting the self-input and the data element received from the remote member of the bike rider group.

3. The device of claim 1, further comprising means configured to provide the self-input.

4. The device of claim 1, further comprising a group control module for managing a list of riders in the bike rider group.

5. The device of claim 1, wherein the self-alert or the remote alert include a SOS alert.

6. The device of claim 1, wherein the self-alert or the remote alert include a departing member alert.

8. The device of claim 3, wherein the means are means configured to provide the self-input through a duration of a click action using a button of the device.

9. A method, comprising: in a bike carrying a member of a bike rider group acting as self-rider:
detecting an alert relevant to the self-rider based on a data element reflecting a self-input provided by the self-rider and on a data element received from another member of the bike rider group using vehicle-to-everything (V2X) communications; and
displaying the alert relevant to the self-rider with minimal distraction to the self-rider.

10. The method of claim 9, wherein the self-input is provided by the self-rider by clicking for a predetermined duration on a button of a device running the method.

11. The method of claim 9, wherein the data element reflecting a self-input is provided by analyzing the self-input in a rider input analyzer module.

12. The method of claim 9, wherein the displaying the alert relevant to the self-rider with minimal distraction to the self-rider includes displaying the alert on a display of a device running the method.
